(19) United States
(12) Patent Application Publication
(10) Pub. No.: US 2006/0144246 A1
(43) Pub. Date: Jul. 6, 2006

(54) Portable utility stand

(76) Inventor: Larondo Holliday, Frankton, IN (US)

Correspondence Address: RITCHISON LAW OFFICES, PC;John D. Ritchison, Suite A, 115 East Ninth Street, Anderson, IN, 46016-1509, US

(21) Appl. No.: 11/324,665

(22) Filed: Jan. 3, 2006

Related U.S. Application Data
(60) Provisional application No. 60/641,366, filed on Jan. 4, 2005.

(51) Int. Cl. A47J 37/12

(52) U.S. Cl. 99/403

(57) ABSTRACT

An auxiliary mechanism for cooking called a Portable Utility Stand. These stands are useful to persons when they are frying turkeys, game and other food using a deep cooking fryer. However, there are a multitude of other uses for this unique device. This device features a wide base assembly, a vertical support assembly and a hanger assembly. The configuration enables the device to securely support and suspend the inner basket and the contents, such as a turkey, above the cooking vessel. This suspension of the food allows the excess oils to drip back into the vessel. A person may quickly assemble and disassemble the compact portable device without tools.

### CROSS-REFERENCE TO RELATED APPLICATIONS

This application claims the benefit of Provisional Patent Application Ser. No. 60/641,366 filed Jan. 4, 2004 by Larondo L. Holliday and titled “Portable Utility Stand”.

### FIELD OF INVENTION

This invention relates to a portable and versatile utility stand (Portable Utility Stand). Particularly these utility stands are useful to persons when they are using a deep cooking fryer. The present invention relates generally to cooking devices and apparatus and, more particularly, to accessories for use by people frying turkeys, game and other foods. However, as the description will show, there are a multitude of other uses for this unique device.

### FEDERALLY SPONSORED RESEARCH

None.

### SEQUENCE LISTING OR PROGRAM

Not Applicable.

### BACKGROUND—FIELD OF INVENTION

The new Portable Utility Stand described in this specification is an auxiliary mechanism that is designed to be easily and quickly assembled for use. Once assembled this utility stand device are particularly useful to persons when they are cooking with a deep cooking fryer. The present invention relates generally to cooking devices and apparatus and, more particularly, to accessories for use by people frying turkeys, game and other foods. There are no known devices at the present time which fully meet this need with as few components and superior operation as the present device. It is believed that this device is made with fewer parts, is of a more durable design, and is with much improved capabilities than any previous cooking stand accessories and devices.

A. Introduction of the Problems Addressed

A person using a deep turkey fryer is often faced with hot oil dripping around the cooking kettle. This is caused from the cooking device not having an easy way to permit the oil to drip back into the kettle, or to “hang” the cooking basket and lid directly over the kettle. Often the hot oil drips on the floor or base below causing areas with potential slippage and allowing the hot oil to drip onto the user, resulting in severe burns. Mechanisms have not been specially designed to address this problem and need.

B. Prior Art

Historically, turkey fryers and other cooking vessels have presented challenges with the oil drippings and high heat associated. Also, the vessels and content were often heavy for common, lighter duty racks. Hence, the stands created were rarely portable or simple to use. The following prior art will first address the turkey fryers and some attempts to remedy the dripping oil challenge. Then, former art that provided some portable utility stands will be discussed which might have provided a solution. In use, the prior art devices were often complex, difficult to assemble and limited in use. The new Portable Utility Stand addresses these limitations and provides a solution to the stated problems.

Examples of prior auxiliary mechanisms for cooking vessels begin with U.S. Pat. No. 309,249 issued to Rains (1884). This teaches a removable inner vessel that has contiguous straps on its exterior surface. These straps permit the inner vessel to be raised and then the straps become a means to hold the inner vessel on the uppermost edge of the outer cooking vessel. The inner vessel is not fully removed from the outer vessel and in the case of a turkey fryer, the inner vessel or basket, as it is commonly called, would still be in the cooking oil. Another improvement for cooking vessels was issued to Follett as a U.S. Pat. No. 211,076 (1878). It teaches a plurality of hinged straps which may pivot and “hook” an inner perforated vessel to the uppermost edge of the outer vessel. The practicality of getting the hooks to pivot on the hinges and dealing with the extreme heat of the straps is not taught. Also the center of gravity of the whole device when in the extended position appears to be a top heavy and unsafe configuration as compared to the manner the new Portable Utility Stand addresses the needs.

A later day mechanism for deep fryers and the handling of inner baskets is taught by U.S. Pat. No. 5,813,321 issued to Bourgeois (1998). It teaches a fully manual mechanism for lifting the inner basket. This prior art demonstrates the need to have a safe, easy means to raise the inner basket, then let it be safely suspended over the outer cooking vessel while the oils drip free. This need is fully addressed by the new Portable Utility Stand device. Another U.S. Pat. No. 5,896,810 issued to Barbour (1999) demonstrates the need again with a hand-held hook device. This art shows no manner for suspending the contents or the inner basket.

A unique and simple apparatus that partially addresses the need in U.S. Pat. No. 5,918,535 was issued to Moreau (1999). This art teaches a short, hand-held apparatus that “hooks” the side of the inner basket, then rests the inner basket in a tilted position. The apparatus engages the inner basket through one to the perforations, then engages the uppermost edge of the outer cooking vessel. The apparatus does not permit the inner basket to be fully external to the cooking chamber. In the case of a turkey fryer, the inner basket would likely still be submerged into some amount of cooking oils.

An attempt to address the need was furthered by the mechanism taught in U.S. Pat. No. 6,314,869 B1 issued to Bourgeois (2001). This art shows a turkey fryer with a two-rod device that rests on the top of the cooking vessel. This supports the basket or plate holding the turkey. There is no teaching as to hoe to secure the turkey at the top although an open handle is shown. The device and use appears top-heavy and possible unsafe in use when compared to the operation of the Portable Utility Stand as described below. A U.S. Pat. No. 6,711,992 issued to McLemore (2004) teaches another hook device for pulling the inner basket vertical. However, there is no teaching of a means to safely and securely hold the basket above the cooking vessel. This would permit the turkey of food to allow the excess oil to safely drip and return to the cooking vessel below.

Next, a discussion of prior devices and mechanisms for holding inner cooking baskets and other items. The U.S. Pat. No. 1,452,640 issued to Hulick (1922) teaches a versatile camp cooking device. The connection of most of the parts were threaded and there were vertical members that engaged/extended into the earth. The device could be disassembled for storage. The overall strength of the members in order to hold a turkey and a basket is not addressed. The focus on convenient ways to hold frying pans is taught and a hook device is shown. The new Portable Utility Stand appears to be less complex and relatively easier to assemble and the disassemble and store. There also is no need to drive part of the frame into the earth for stability. A collapsible clothes support is taught in U.S. Pat. No. 3,507,402 issued to Barbee (1970). A portable stand teaches a support for electric flood lights in a U.S. Pat. No. 4,228,489 issued to Martin (1980). Both patents show collapsible or portable hanging devices. They lack, however, a means to accommodate a turkey fryer below without significant changes to the base support configuration. The manner and ability to support the weight of an inner basket with its contents is not taught.

A lantern stand with a reflector is taught by a U.S. Pat. Des. 337,849 issued to Bradley (1993). The drawings show a relatively lighter tubular construction with a three-legged support. The device appears to be portable, but only the ornamentation is shown. The stability of the work piece is not addressed and can not be ascertained from the ornamentation depicted. A more recent cooking support device is taught in U.S. Pat. No. 5,307,789 issued to Newby (1994). This device requires installation tools, fasteners, and extra members as compared to the Portable Utility Stand. It teaches a permanent device that has no stated portability. Use with a turkey fryer per say is not taught and the vertical clearance for a cooking chamber and a perforated basket is not addressed.

A portable stand is taught in U.S. Pat. No. 5,860,410 issued to Hollingsworth, Jr. (1999). This stand is square tubing and made to accommodate various heaters, lights, and camp stoves. Its use with or as a turkey fryer auxiliary device is not discussed or taught. The device is more complex, has more parts, and does not appear to accommodate turkey fryers. A portable hunting and fishing stand is taught in U.S. Pat. No. 6,322,026 B1 issued to Ju (2001). The device is a set of interlock rods with a hook and loop configuration that permits assembly without tools. The device does not address use as a cooking stand or for use with heavy articles such as a turkey fryer basket and contents. Another lantern support stand is taught in U.S. Pat. No. 6,457,683 B1 issued to Armstrong, Sr. (2002). This device is not freestanding and is relatively light weight compared to the Portable Utility Stand. Discussion for use as a cooking stand is mentioned only for small, light camp stoves and not turkey friers. None of the prior art teaches all the features and capabilities of the Portable Utility Stand.

### SUMMARY OF THE INVENTION

A Portable Utility Stand has been developed for use by persons that cook various game and other foods. A cooking person normally tries to cook the meat or vegetables and then remove the same from the fire when the food is “done”. Unfortunately, when the cooking means is by frying on a natural fire, a gas fired burner or the like, the tendency and current art only permits removing the lid and basket from the frying oils without any real control or safe means to prevent oil dripping. This dripping in and around the fuel could potentially cause a fire, could burn the person moving the lid, or minimally could result in an oily “mess” to clean-up. Specifically, the Portable Utility Stand provides a manner to control the cooking oil drippings and permit the basket to drip clean. This provides the cooking person with a safe means to control the splash and drip from the oils.

The Portable Utility Stand consist primarily of three detachable assembles: a base assembly for support and stability; a vertical assembly with a means to adjust the height; and a hanger assembly for use with the cooker including the lid, basket, utensils and the like.

### OBJECTS AND ADVANTAGES

There are several objects and advantages of the Portable Utility Stand. There currently exist few mechanisms for aiding and controlling food fryers that are made efficiently to use and with few parts. In this regard, it would be advantageous to have an improved Portable Utility Stand which permits the cooking person to have a reliable, inexpensive device to easily control the oil drip and potential fire hazard he or she is facing. This improvement provides more convenience and safety associated with frying foods on an open fire.

One advantage and object of the present invention is to provide a Portable Utility Stand for cookers which is light and easy to use in the field. The device may be quickly and easily assembled and presented for use with a fryer device without the need of any tools.

Another advantage is the stability of the stand once assembled. The wide base assembly permits the Portable Utility Stand to safely balance a significant load that is at or near the top of the stand. This stability of the device allows it to be used in many other ways than just as a cooking accessory. The highly versatile Portable Utility Stand may be used in the other manners ways as described in a table below.

A specific need to have an inexpensive, affordable device is another objective. The configuration of this device reduces the number of parts by combining the fastening and adjusting mechanisms of prior art into integral components. This unique and new combination thus provides an easier assembly and more durable device. Since some of the components anticipate combined parts to eliminate fastening in assembly, the need for tools to assemble is avoided. For the process of manufacturing the Portable Utility Stand, the investment for tooling is also less expensive. This is accomplished by utilizing common parts of tubes, connectors and other structural parts that are readily available for commercial use.

A further objective is satisfying a long term need to prevent the mess or safety hazard of oil being spilled during the cooking process. The reduction of splash and burn potential from the current fryers will improve the overall safety of the cooking means. Here, the oil splash may be controlled and provide a reduced likelihood of burning a cooker or on-looker.

Another objective is to provide a simple, high quality device that is durable for continued use. The design of the preferred square tubing permits a strong device that will endure yeas of use and/or abuse. The exterior is coated to facilitate easy cleaning and to prevent oxidation or other deterioration.

Another convenience for this invention is the portability of the device. The entire assembly may be easily disassembled without tools and carried portably in a canvas bag or the like.

Finally, other advantages and additional features of the present Portable Utility Stand will be more apparent from the accompanying drawings and from the full description of the device. For one skilled in the art of devices and improvements for cooking devices, it is readily understood that the features shown in the examples with this mechanism are readily adapted to other types of cooking improvements and utility stands.

### DESCRIPTION OF THE DRAWINGS—FIGURES

The accompanying drawings, which are incorporated in and constitute a part of this specification, illustrate an embodiment of the Portable Utility Stand Device that is preferred. The drawings together with the summary description given above and a detailed description given below serve to explain the principles of the Portable Utility Stand Device. It is understood, however, that the Portable Utility Stand Device is not limited to only the precise arrangements and instrumentalities shown.

The drawings and illustrations include:

FIG. 1 is a Photograph of a prototype assembly and the preferred embodiment of the Portable Utility Stand Device.

FIG. 2 is an Isometric sketch of an alternative embodiment of a Portable Utility Stand.

FIG. 3 for FIGS. 3 A and 3 B are pictures of the side and front view of the preferred embodiment for the present invention Portable Utility Stand.

FIG. 4 is a Photograph that shows the base assembly for the invention.

FIG. 5 is a Photograph that shows the base assembly and the vertical extension for the invention.

FIGS. 6 A through 6 C provide details of the hanger device used in the Portable Utility Stand.

FIG. 7 show photographs of the prototype of the components of the preferred Portable Utility Stand.

FIG. 8 are sketches of a prototype of the Portable Utility Stand 31A to help explain an alternative embodiment of the novel device. FIG. 8A is an isometric of the device and FIG. 8 B provides the components of the alternative embodiment.

FIGS. 9 A through 9 G show the Photographs of the prototype test samples being assembled and adjusted as needed.

FIGS. 10 A through 10 C provide operational details of the Portable Utility Stand.

### DESCRIPTION OF THE DRAWINGS—REFERENCE NUMERALS

The following list of detail items refers to the drawings:
31 general assembly of the Portable Utility Stand
31A alternative assembly with multi-piece hanger
32 base assembly
33 vertical support assembly
34 one-piece hanger assembly
35, 35A side support member(s)
36 cross connector
37 vertical extension—no apertures
37A vertical extension with apertures for connection
38 vertical support member w/utensil hook
38A alternative vertical support member w/all hooks
38B expanded band on member 38 to bear hanger 34
39 alternative (to 34) multi-piece hook assembly
40 horizontal member
41 angle support member
42 angel retainer for 41
43 slot for 40
44 vertical connector from 40 to 41
45 hook detail
46 utensil hook
47 lid hook
48 apertures for connection means 49
49 connection means (detent, etc.) with apertures 48
50 tote bag
51 fryer basket (inner vessel)
52 cooker pot (outer vessel
53 burner support
54 heat source
55 lid
56 utensils
57 thumb wheel stud
58 retainer nut
59 adjustment apertures (in 37A)
60 person assembling the Portable Utility Stand
61 plastic end cap

### Detailed Description of Perferred Embodiment

The present device is a mechanism for use with a deep fryer called a Portable Utility Stand 31. The Portable Utility Stand 31 consist primarily of three detachable assembles: a base assembly 32 for support and stability; a vertical assembly 33 with a means to adjust the height; and a hanger assembly 34 for use with the cooker including the lid, basket, utensils and the like. A person having ordinary skill in the field of general cooking and support assemblies such as these appreciates the various parts that may be used to physically permit this Portable Utility Stand 31 to be produced and utilized.

The improvement over the existing art is providing a device that:

Is light and easy to use, may be quickly assembled and presented for use with a fryer device without the need of any tools, and is portable;

Has high stability once the stand is assembled and is very versatile for other uses;

Is an inexpensive, affordable device;

Provides an easier assembly and a more durable, high quality device;

Satisfies a long term need to prevent the mess or safety hazard of oil being spilled during the cooking process; and

Improves the overall safety by reducing the splash and burn potential from the current fryers.

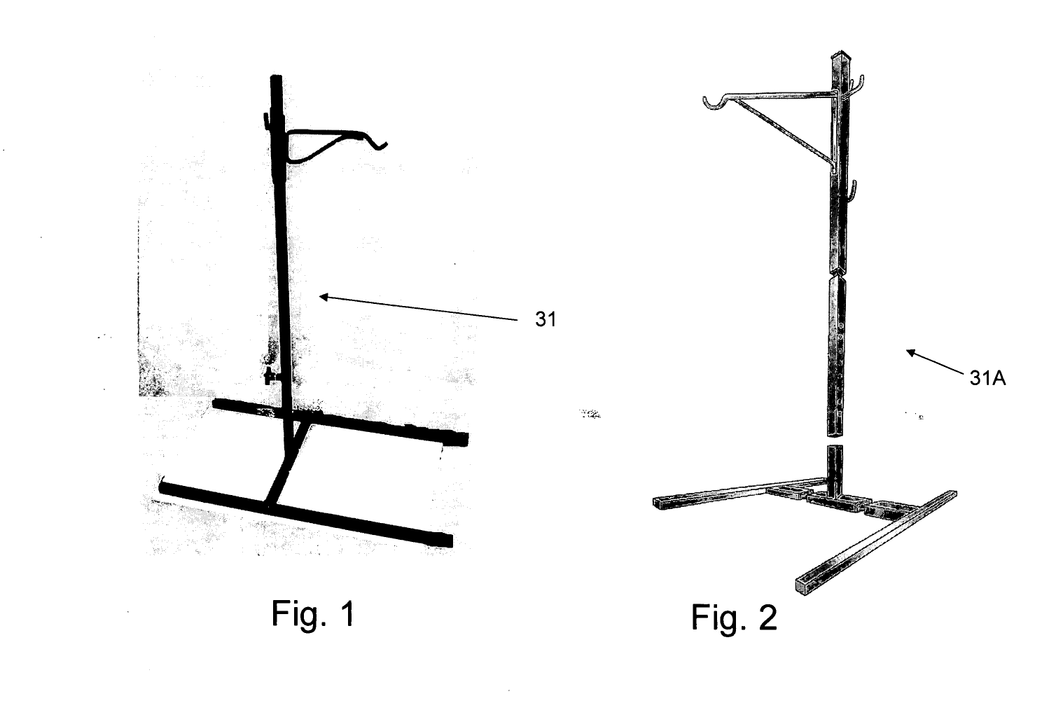

There is shown in FIGS. 1-10 a complete operative embodiment and method of using the Portable Utility Stand Device 31. In the drawings and illustrations, one may note well that the FIGS. 1-10 demonstrate the general configuration of this invention. The preferred embodiment of the device is comprised of only a few parts as shown in the drawings and photographs. These parts include, but are not limited to:
a base assembly 32 generally comprised of a two side support members 35 and 35A and a cross connector 36;
a vertical support assembly 33 generally comprised of a vertical extension 37 and a vertical support member 38; and
a hanger assembly 34. Between each assembly, there are simple connectors which are described below in detail.

The accompanying drawings, which are incorporated in and constitute a part of this specification, illustrate an embodiment of the Portable Utility Stand that is preferred 31 and one that is an alternative 31A. The drawings together with the summary description given above and a detailed description given below serve to explain the principles of the Portable Utility Stand 31.

FIG. 1 is a Photograph of the first prototype assembly of the Portable Utility Stand Device 31. This is the preferred embodiment.

FIG. 2 is an Isometric sketch of the Portable Utility Stand 31A in an alternative embodiment.

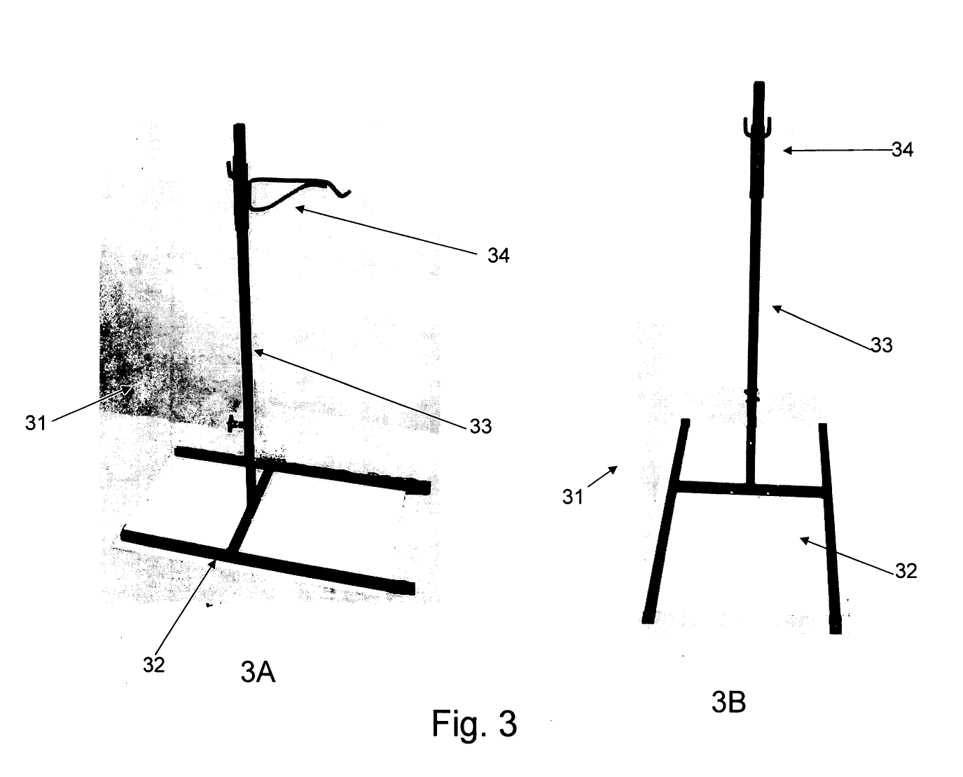

FIG. 3 for FIGS. 3 A and 3 B are pictures of the side and front view of the preferred embodiment of the Portable Utility Stand 31. Here one may see in each FIG. 3A and FIG. 3B that the base assembly 32 is connected generally to the adjustable vertical support assembly 33. This vertical support assembly 33 then bears the hanger assembly 34 to complete the overall Portable Utility Stand 31.

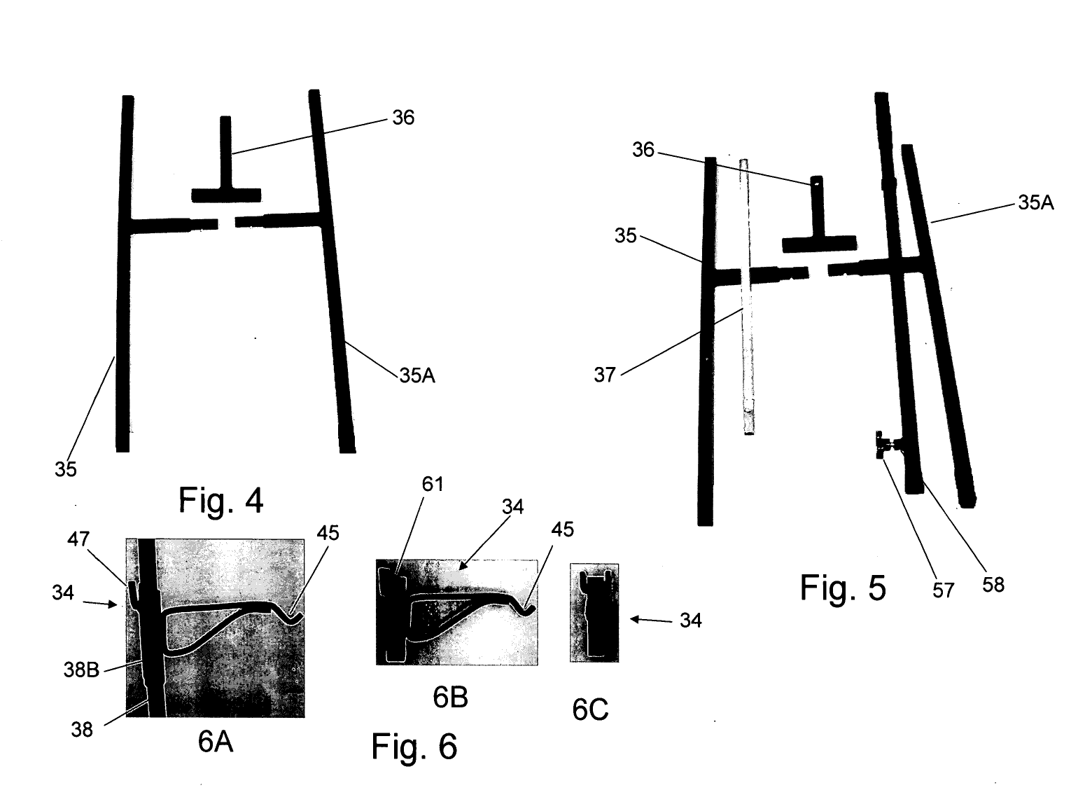

FIG. 4 is a Photograph that shows the base assembly 32 for the invention. Here the two support members 35 and 35A are positioned opposite of each other. Then, the cross connector 36 is shown positioned and ready for assembly as described below. All of these members 35, 35A and 36 are comprised of a tubular structure with a rectangular, square, round, oval or the like cross section. The instant photograph illustrates a square tube as an example. One well skilled in the art appreciates there are a plethora of structural shapes that would fall within the spirit and scope of the present Portable Utility Stand 31 members. Therefore the photographs are exemplary and not limiting in the scope. Likewise, the photographs show a steel tube that has been powder coated to resist corrosion. Additionally, each tubular member that has an “open” end is featured with a plastic end cap 61 to prevent moisture from entering into the interior of the tubes. Again, the materials of which the members 35, 35A and 36 may be produced are of many types such as other metals (aluminum, stainless, etc.) composite materials, high temperature resistant plastics, certain woods, and other suitable materials that provide strength and the resistance to high temperatures and corrosion.

FIG. 5 is a Photograph that shows the parts of the base assembly 32 and the parts for the vertical support assembly 33 for the invention. Here, the same base assembly parts described in FIG. 4 are repeated. Additionally, the vertical extension 37 and the vertical support member 38 are shown. The vertical extension 37 is smaller in cross section than the vertical support member 38 to permit the vertical extension 37 to “telescope” inside the vertical support member 38. The cross section and material makeup of these parts are like those described above for the structural member 35, 35A and 36. One also views that at the one end of the vertical support member 38, the adjustable connector is comprised of the thumb wheel stud 57 and the retainer nut 58. These are described further, below.

FIGS. 6 A through 6 C show details of the hanger assembly 34 used in the Portable Utility Stand 31. Here in FIG. 6A the one piece hanger assembly 34 has various parts shown. Particularly the main hook 45 and the lid hook 47 are viewed. Additionally, the vertical support member 38 shows the expanded band 38B which bears and supports the hanger assembly 34. In FIG. 6B, the side view of just the hanger assembly 34 shows the main hook 45 and plastic end cap 61, or the like. An End View in FIG. 6C shows the hanger assembly 34 from still another vantage point. The materials and structural cross section of the hanger assembly 34 are generally like the other members described above. In addition, some cross pieces are a common, solid material often known as “strap” or flat material. This has taken form as required to provide the lid hook 47, the main hook 45 and other support means.

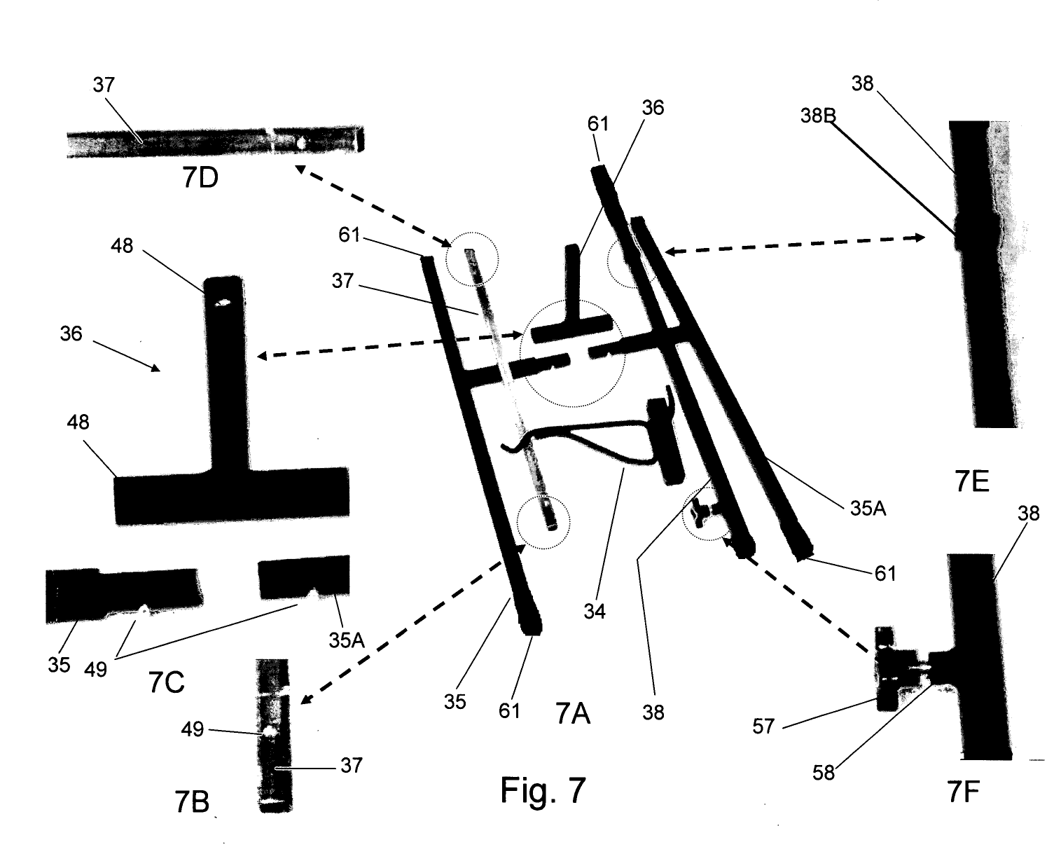

FIG. 7 shows several photographs and details of the components of the preferred Portable Utility Stand 31. There are a total of six (6) parts comprising the Portable Utility Stand 31 which are shown in FIG. 7A:
two (2) support members 35 and 35A;
cross connector 36;
vertical extension 37;
vertical support member 38; and
hanger assembly 34.
   One notes that throughout these exploded views, the end cap 61, or the like, is shown to seal an open tube end.

FIG. 7B is an enlarged view of the lower end of the vertical extension 37. Here the detent feature 49 is shown. This feature may be one of many known ways to have an adjustable yet secure method to inter-connect two telescoping members such as vertical support member 38 and vertical extension 37. These are readily available as spring and rod devices that may be threaded and fastened directly into the tube of vertical extension 37 or slid internally into the end of the tube to the awaiting aperture 48 in the vertical extension 37. Alternatively, but not preferred, is a separate rod or bar that transverses the entire vertical support member 38 and vertical extension 37 and is removable. These types are often used with weight lifting benches where the loads are much greater than experienced here. Another means is described below as an alternative. Empirical data has shown the thumb wheel 57 tightened against the vertical extension 37 as more than sufficient to securely connect the components. One skilled in the art appreciates the many options that provide adjustable extension in the vertical direction and are still well within the scope of this invention.

FIG. 7C is an enlarged view of the ends of the support members 35 and 35A and the cross connector 36. Again, the detent feature 49 is shown as well as the receiving apertures 48 at all the three ends of the cross connector 36. FIG. 7D is a view that has been expanded to show the features. This shows the higher end and opposite end of the vertical extension 37 from that described in FIG. 7B. Here the detent feature 49 to engage the aperture 48 in the hanger assembly 34 is shown.

FIG. 7E is an enlarged view of the higher end of the vertical support member 38. Here the expanded band 38B is detailed. This band 38B bears the hanger assembly 34 and supports it in a “telescoping” manner. FIG. 7F is an enlarged view of the opposite end of the vertical support member 38. Here the thumb wheel stud 57 and retainer nut 58 are detailed. These provide a means to adjustably yet securely connect the vertical support member 38 to the internally telescoped vertical extension 37. Here the thumb wheel stud 57 is tightened against the vertical extension 37 as a means for securing the device.

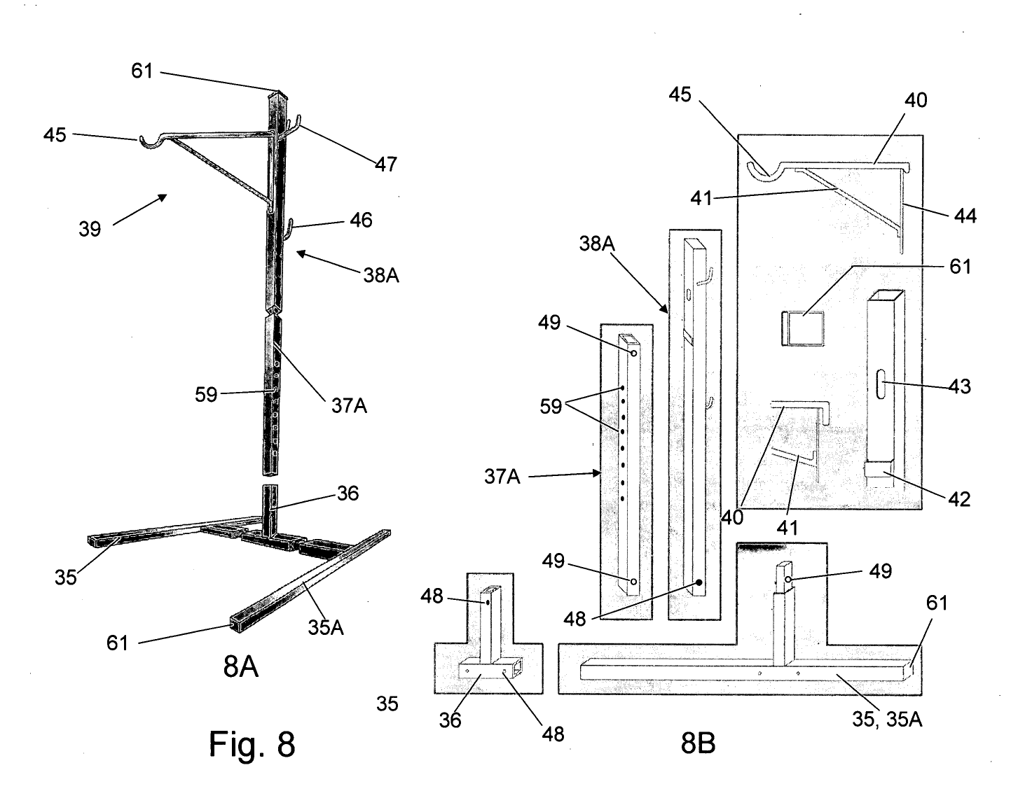

FIG. 8 are sketches of an alternative embodiment of the Portable Utility Stand 31A. These sketches help explain the components of an alternative embodiment of the novel device. FIG. 8A is an isometric of the device and FIG. 8 B provides the components of the alternative embodiment.

In FIG. 8A, the base assembly components 35, 35A and 36 are essentially the same as described for the preferred embodiment. The vertical extension 37A is similar with apertures 59 for engaging with the thumb wheel stud 57. Here, these apertures 59 receive the thumb wheel stud 57 described above in FIG. 7F. The thumb wheel stud 57 (on the vertical support member 38A) traverses through the apertures 59 of the vertical extension 37A and provides secure, yet detachable connection between the Additionally, the vertical support member 38A is different in that it contains the hook features for the lid hook 47 and the utensil hook 46. Further, an alternative hanger device 39 is comprised of a main hook 45, a horizontal member 40, an angle member 41 and a vertical member 44 that is removably connected to the vertical support member 38A by means of a slot 43 and retainer 42. Both 42, 43 are integral to the vertical support member 38A. This essentially means the hanger assembly 39 “hangs” from the top of vertical support member 38A rather that being born by the vertical support member 38 by means of the expanded band 38B in the preferred embodiment 31. In FIG. 8B, individual sketches of the components of the alternative embodiment are presented. These components are described above.

The details mentioned here for the preferred and alternative embodiments are exemplary and not limiting. Other specific components specific to describing a Portable Utility Stand 31 may be added as a person having ordinary skill in the field of support assemblies and stands well appreciates.

### Operation of the Preferred Embodiment

People using deep fryers for cooking fully understand the hazards and mess associated with the hot cooking oil. Hence, the cooker using the device may well understand and appreciate the above described benefits of having a means to support the lid, utensils and loaded basket during the operation.

The new Portable Utility Stand 31 has been described in the above embodiment. The manner of how the device is assembled and operates is described below. One notes well that the description above and the operation described here must be taken together to fully illustrate the concept of the Portable Utility Stand 31.

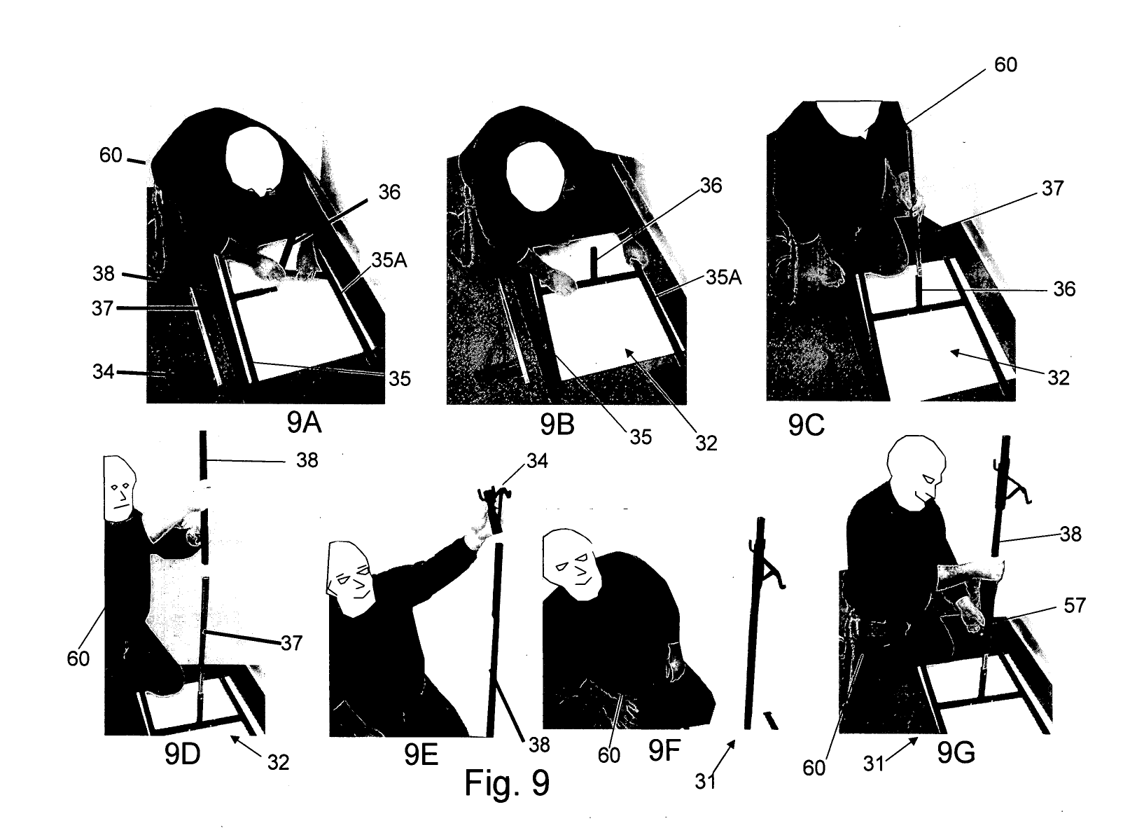

FIGS. 9 A through 9 G show the Photographs of the prototype sample being assembled and adjusted as needed. FIG. 9A shows the essential six parts described above ready to assemble. The support members 35 and 35A are laid out opposing each other and the cross connector 36 is placed between them (35 and 35A). Then the cross connector 36 is removably attached to each of the support members 35 and 35A by the assembling person 60. This attachment is by means of the detent feature 49 and receiving apertures 48 (not shown here, but described and shown in the specification above and other drawings contained within). In FIG. 9B this assembly of the base assembly 32 is completed and the top of the cross connector 36 is vertical. Next in FIG. 9C, the person 60 places the vertical extension 37 into the end of the cross connector 36. One remembers from the above description that the vertical extension 37 is a smaller cross section and easily “telescopes” into the cross connector 36 and the vertical support member 38.

In FIG. 9D the vertical support member 38 is placed over the vertical extension 37 and connected by means of the thumb wheel stud 57 tightened against the vertical extension 37. In FIG. 9D, the hanger assembly 34 is placed over the vertical support member 38. The person 60 reviews the height of the hanger 34 in FIG. 9F. The person 60 then adjusts the height of the Portable Utility Stand 31 to a suitable position as shown in FIG. 9G. He then adjusts by changing the interface location of the thumb wheel stud 57 on the vertical support member 38 and the vertical extension 37.

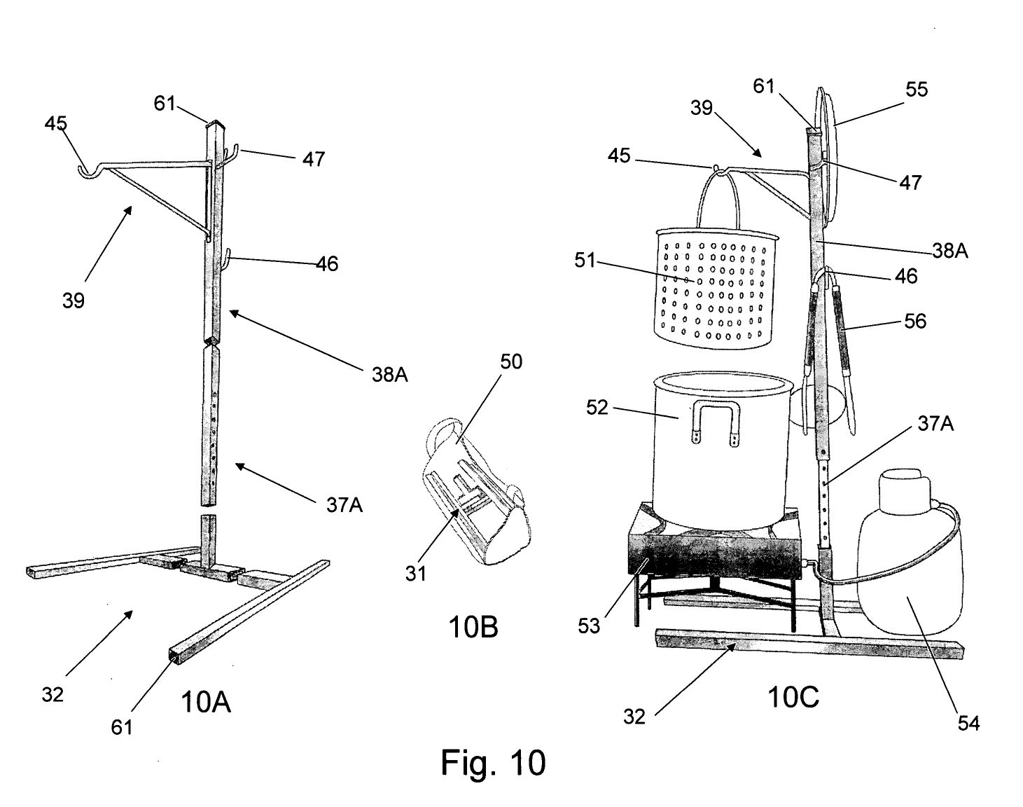

FIGS. 10 A through 10 C provide additional operational details of the Portable Utility Stand 31 and 31A. FIG. 10A is similar to the drawing of the alternative embodiment 31A described above. One skilled in the art appreciates that the alternative embodiment is assembled similarly to the preferred embodiment 31 described in FIGS. 9A through 9G above. In FIG. 10B, a disassembled Portable Utility Stand 31 has been placed in an easily carried and stored tote bag 50. This compact storage provides an easy means to store the device or to carry the device on camping trips and other outside adventures. This collapsible and portable feature is a significant improvement to other prior utility stands.

FIG. 10 C shows a Portable Utility Stand 31 or 31A in full use. Once assembled, the Portable Utility Stand 31 is used in association with other devices. Here, the Portable Utility Stand 31 is used with a deep fryer. One notes the Portable Utility Stand 31 straddles the heat source 54 and burner support 53. This permits the oil to safely and cleanly drip into the cooker 52. The Burner support 53 bears the cooker 52. The fryer basket 51 then may be elevated and held by the hook 45 of the Portable Utility Stand 31. The fryer basket 51 is safely and securely suspended or hung above the cooker vessel 52. One further notes that the Portable Utility Stand 31 permits the lid 55 to be held by the lid hook 47 and the utensils 56 and the like are held on the utensil hook 46.

There are many other conceivable uses for a Portable Utility Stand 31. A few have been illustrated below in TABLE A. These uses described above and in the table below are exemplary and not limiting.

TABLE A
Examples of Other Uses

| Item | Description | Comment |
|---|---|---|
| 1 | Deep Fryer Stand | Cooking Accessory |
| 2 | Light Stand | Electric, gas, etc. |
| 3 | Game Stand | Fish, game etc. for skinning |
| 4 | Rotisserie stand | Cooking |
| 5 | Perimeter Stand | Lights, pest repellants |
| 6 | Tool Shop Stand | Tools, cords, lights, etc. |
| 7 | Cleaning Stand | Washing equipment, clothes, etc. |
| 8 | Auto Accessory Stand | Lights & tools |
| 9 | Hobby Stand | Display, work |
| 10 | Plant Hanger stand | Display |
| 11 | Sign Hanger | Display |
| 12 | Mechanic Stand | Work Assist |
| 13 | Craft Stand | Display, work |
| 14 | Swim area | Accessory stand |
| 15 | Musician Stand | Music, Instruments, etc. |
| 16 | General Hanger Stand | Miscellaneous uses |

With this description it is to be understood that the Portable Utility Stand 31 is not to be limited to the disclosed embodiment. The features of the Portable Utility Stand 31 are intended to cover various modifications and equivalent arrangements included within the spirit and scope of the description.

What is claimed as new and desired to be protected by Letters Patent is:

1. An auxiliary device for use with cooking food by a hot oil in a turkey fryer by safely and securely suspending an inner cooking basket directly above a cooking vessel, comprising:
(a) a base assembly for support and stability;
(b) a vertical assembly with a means to adjust the height
(c) a hanger assembly; and
(d) a means for removably connecting the base, vertical and hanger assemblies into one portable utility stand
whereby the device provides a means to allow the inner basket and fried food to be held in place while the excess oil drips and returns to the cooking vessel below.

2. The device according to claim 1 wherein the means for removably connecting the base, vertical and hanger assemblies into one portable utility stand is an insertion system with one assembly having expanded perimeter on the receiver tubes that slides exteriorly to the interior tubes of another assembly with a standard perimeter of a tube and a means to rigidly secure the contiguous tubes of the assemblies
whereby the insertion system and the means to secure provide a rigid portable utility stand without the use of tools.

3. The device according to claim 2 wherein the means to rigidly secure the tubes is an aperture in the exterior, expanded tube and a spring detent pin on the inner tube.

4. The device according to claim 2 wherein the means to rigidly secure the tubes is apertures through opposite sides of the exterior, expanded tube; apertures through opposite sides of the inner, standard sized tube; and a pin and cotter key that is engaged through both exterior and interior apertures once the apertures of each tube are aligned with each other contiguous aperture.

5. The device according to claim 2 wherein the means to rigidly secure the tubes is apertures through opposite sides of the exterior, expanded tube; apertures through opposite sides of the inner, standard sized tube; and a threaded bolt and nut whereby the bolt is engaged through both exterior and interior apertures once the apertures of each tube are aligned with each other contiguous aperture and then the nut is threadably secured to the bolt.

6. The device according to claim 1 wherein the means for removably connecting the base, vertical and hanger assemblies into one portable utility stand is a threaded system with the tubes of the assembles being exteriorly and interiorly threaded to permit a rigid attachment of all the assemblies.

7. The device according to claim 1 wherein the base, vertical and hanger assemblies are made of a durable material which is configured with a series of hollow tube structures
whereby the overall strength and durability of the portable utility stand is increased relative to solid structures and other non-tubular structures.

8. The device according to claim 7 wherein the material of the tube assemblies is metal.

9. The device according to claim 8 wherein the metal of the tube assemblies is steel.

10. The device according to claim 9 wherein the steel of the tube assemblies is stainless.

11. The device according to claim 9 wherein the steel of the tube assemblies has an exterior surface finish.

12. The device according to claim 8 wherein the metal of the tube assemblies is aluminum.

13. The device according to claim 7 wherein the material of the tube assemblies is a composite material.

14. The device according to claim 13 wherein the composite material is a plastic.

15. The device according to claim 7 wherein the hollow tube structure is a rectangular cross section.

16. The device according to claim 7 wherein the hollow tube structure is a round cross section.

17. The device according to claim 7 wherein the hollow tube structure is an oval cross section.

18. An auxiliary support device for a variety of uses, comprising:
(a) a base assembly for support and stability;
(b) a vertical assembly with a means to adjust the height
(c) a hanger assembly; and
(d) a means for removably connecting the base, vertical and hanger assemblies into one portable utility stand
whereby the assembled device provides a means to temporarily support various items and then be disassembled without tools for portability and storage of the device.

19. The device according to claim 18 wherein the variety of uses is selected from the group consisting of Light Stand, Game Stand, Rotisserie stand, Tool Shop Stand, Cleaning Stand, Auto Accessory Stand, Hobby Stand, Plant Hanger Stand, Sign Hanger, Mechanic Stand, Craft Stand, Musician Stand, and General Hanger Stand.

20. An auxiliary support device for a variety of uses, comprising:
(a) a base assembly 32 generally comprised of two side support members 35 and 35A and a cross connector 36 for support and stability;
(b) a vertical support assembly 33 generally comprised of a vertical extension 37 and a vertical support member 38 with a threaded aperture and threaded thumbwheel to adjust the height
(c) a hanger assembly; and
(d) a means for removably connecting the members and extenders into one portable utility stand
whereby all the members consist of square, hollow steel tubes which are exteriorly powder coated assembled device provides a means to temporarily support various items and then be disassembled without tools for portability and storage of the device.
